(19) United States
(12) Patent Application Publication
(10) Pub. No.: US 2011/0122786 A1
(43) Pub. Date: May 26, 2011

(54) AUDIO CODEC BIT-RATE CONTROL METHOD FOR ASSURING QoS OF VOICE IN WLAN

(75) Inventors: Ki-Jong Koo, Daejeon-City (KR); Do-Young Kim, Daejeon-city (KR); Byung-Sun Lee, Daejeon-city (KR)

(73) Assignee: Electronics and Telecommunications Research Institute, Daejeon-city (KR)

(21) Appl. No.: 12/808,525

(22) PCT Filed: Jul. 9, 2008
(86) PCT No.: PCT/KR2008/004021

§ 371 Date: Jun. 16, 2010

(30) Foreign Application Priority Data
Dec. 17, 2007 (KR) 10-2007-0132730

(51) Int. Cl. H04L 12/26; H04W 84/02; H04L 12/66

(52) U.S. Cl. 370/252; 370/338; 370/352

(57) ABSTRACT

A method and apparatus for controlling voice quality in WLAN is provided. The codec bit rate of wireless terminals is adjusted by collecting channel state information for determining a channel occupation time of wireless terminals connected to an access point, adjusting the codec bit rate of the wireless terminals based on channel occupancy of the wireless terminals with respect to total channel capacity, which is determined using the channel state information, and transmitting the adjusted codec bit rate to each of the wireless terminals.

### TECHNICAL FIELD

The present invention relates to a voice quality control in WLAN, and more particularly, to a method and apparatus for assuring the QoS of voice by controlling an audio codec bit rate in WLAN.

### BACKGROUND ART

As user's demands on multimedia services such as audio and video services as well as a data service using the Internet increase, the real-time QoS for stably supplying the multimedia services is required. Particularly, since voice over internet protocol (VoIP) for providing an audio service using the Internet is more sensitive to delay and jitter than data and video, the real-time QoS is more necessary.

Meanwhile, WLAN having advantages of installation convenience and mobility was widely spread from the middle 1990s. Currently, the WLAN is widely used at a speed similar to the wired LAN of 100 Mbps. With the combination of the WLAN and the VoIP, the WLAN also has advantages of mobility and reduced price.

However, since the WLAN using an industrial, scientists and medical (ISM) band of 2.4 GHz has signal attenuation factors such as mobility, fading, multi-path signals and signal interference, the transmission speed of a wireless terminal may be flexibly changed.

The channel occupancy in WLAN may be determined by the transmission speed and data quantity of a wireless terminal. As the transmission speed decreases, the channel occupancy increases. Thus, the channel quality in WLAN is degraded due to external factors. If the transmission speed of the wireless terminal is lowered, the channel occupancy increases although there is no change in transmission data quantity.

For example, a voice service is initially provided by using the G.711 codec and setting the transmission speed of a wireless terminal to be 54 Mbps. If the transmission speed of the wireless terminal is lowered down to 54 Mbps or less due to the degradation of the channel quality, voice data of the G.711 codec are all transmitted, but the channel occupancy is relatively increased.

If the degradation of the channel quality occurs in a plurality of wireless terminals connected to one access point (AP), the channel occupancy of the plurality of wireless terminals increases. Therefore, the deterioration of channels in WLAN may occur because the channel occupancy exceeds a threshold value expected by the wireless terminals at a service start point. Furthermore, all the wireless terminals in a basic service set (BSS) may not normally perform services.

In May 2006, the ITU-T standardized broadband audio codec G.729.1 for supporting a variable bit rate. Since the G.729.1 is compatible for G.729-Annex A, B, the G.729.1 supports a narrowband and reproduces voice of a person to be close to natural voice by adding bands of 50 through 300 Hz and 3400 through 7000 Hz to an existing voice bandwidth. The G.729.1 also has a variable bit-rate characteristic capable of adjusting the quantity of voice data by 2 kbps in a range of 14 through 32 kbps depending on the state of a network. In addition, the G.729.1 has an embedded signaling function capable of controlling the voice data transmission bit rate between codecs during voice communication without a signaling protocol for separately controlling a codec bit rate.

### DISCLOSURE OF INVENTION

### Technical Problem

The present invention provides a method and apparatus for controlling an audio codec bit rate in a VoIP system, wherein the bit rate of the G.729.1 is controlled in WLAN, thereby preventing the deterioration of channels and assuring the QoS of voice.

### Technical Solution

According to an aspect of the present invention, there is provided a method for controlling voice quality in a VoIP system, which includes: collecting channel state information for determining a channel occupation time of wireless terminals connected to an access point (AP); controlling the codec bit rate of the wireless terminals based on channel occupancy of the wireless terminals with respect to total channel capacity, which is determined using the channel state information; and transmitting the controlled codec bit rate.

According to another aspect of the present invention, there is provided an apparatus for controlling voice quality in a VoIP system, which includes: a channel state collector for collecting channel state information for determining a channel occupation time of wireless terminals connected to an AP; a bit-rate calculator for controlling the codec bit rate of the wireless terminals based on channel occupancy of the wireless terminals with respect to total channel capacity, which is determined using the channel state information; and a bit-rate transmitter for transmitting the controlled codec bit rate.

### Advantageous Effects

Most VoIP systems support the G.711 or G.729 codec, considering characteristics of the G.729.1 and channel in WLAN. In the situation, if the G.729.1 is applied to the VoIP systems, the G.729.1 is compatible for the G.729 codec, and the quantity of voice data is controlled using variable bit-rate characteristics of the G.729.1. Accordingly, the QoS of voice can be assured.

### DESCRIPTION OF DRAWINGS

The above and other features and advantages of the present invention will become more apparent by describing in detail exemplary embodiments thereof with reference to the attached drawings in which:

FIG. 1 is a view schematically illustrating the structure of a VoIP network to which a method for controlling voice quality is applied according to the present invention;

FIG. 2 is a flowchart illustrating a method for controlling voice quality according to an embodiment of the present invention;

FIG. 3 is a view illustrating an example of the VoIP system to which a voice quality control is applied according to the present invention;

FIG. 4 is a flowchart illustrating a method for controlling voice quality in the VoIP system illustrated in FIG. 3 according to an embodiment of the present invention; and

FIG. 5 is a block diagram illustrating an apparatus for controlling voice quality in WLAN according to an embodiment of the present invention.

### BEST MODE

According to an aspect of the present invention, there is provided a method for controlling voice quality in a VoIP system, which includes: collecting channel state information for determining a channel occupation time of wireless terminals connected to an access point (AP); controlling the codec bit rate of the wireless terminals based on channel occupancy of the wireless terminals with respect to total channel capacity, which is determined using the channel state information; and transmitting the controlled codec bit rate.

According to another aspect of the present invention, there is provided an apparatus for controlling voice quality in a VoIP system, which includes: a channel state collector for collecting channel state information for determining a channel occupation time of wireless terminals connected to an AP; a bit-rate calculator for controlling the codec bit rate of the wireless terminals based on channel occupancy of the wireless terminals with respect to total channel capacity, which is determined using the channel state information; and a bit-rate transmitter for transmitting the controlled codec bit rate.

### MODE FOR INVENTION

Hereinafter, an apparatus and method for controlling voice quality according to the present invention will be described in detail with reference to the accompanying drawings.

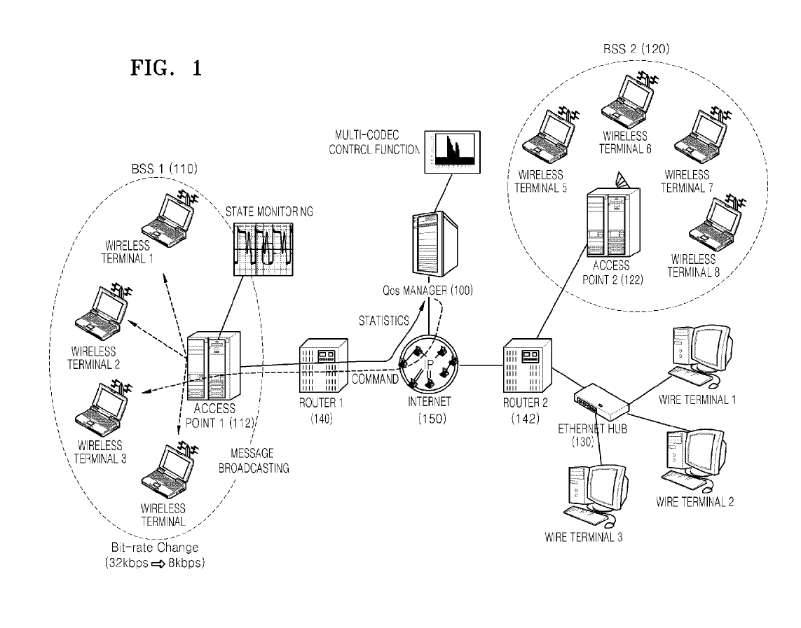

FIG. 1 is a view schematically illustrating the structure of a VoIP network to which a method for controlling voice quality is applied according to the present invention.

Referring to FIG. 1, the VoIP network includes wire/wireless terminals (wireless terminals 1 through 8 and wire terminals 1 through 3) each having the G.729.1 codec embedded therein, access points (APs) 112 and 122, a QoS manager 100, and the like. The VoIP network comprises access networks including several basic service sets (hereinafter, referred to as ‘BSSs) 110 and 120 each having an AP and some wireless terminals connected to the AP. For example, the first BSS 110 includes terminals (wireless terminals 1 through 4) having the G.729.1 codec and WLAN functions embedded therein and a first AP 112. The access network of the first BSS is connected to the Internet 150 through a first router 140. The wire terminals 1 through 3 are connected to the Internet 150 through an Ethernet hub 130 and a second router 142.

Correspondent terminals for communicating with the terminals belonging to the first BSS 110 may be positioned in the first BSS 110 or another BSS 120, or may be terminals (the wire terminals 1 through 3) connected through the Ethernet. At this time, the correspondent terminals should have the G.729.1 codec or at least the G.729 codec embedded therein. The QoS manager 100 manages QoS control functions of receiving information necessary for a QoS control through the APs 112 and 122, transmitting a command for the QoS control to each terminal, and the like.

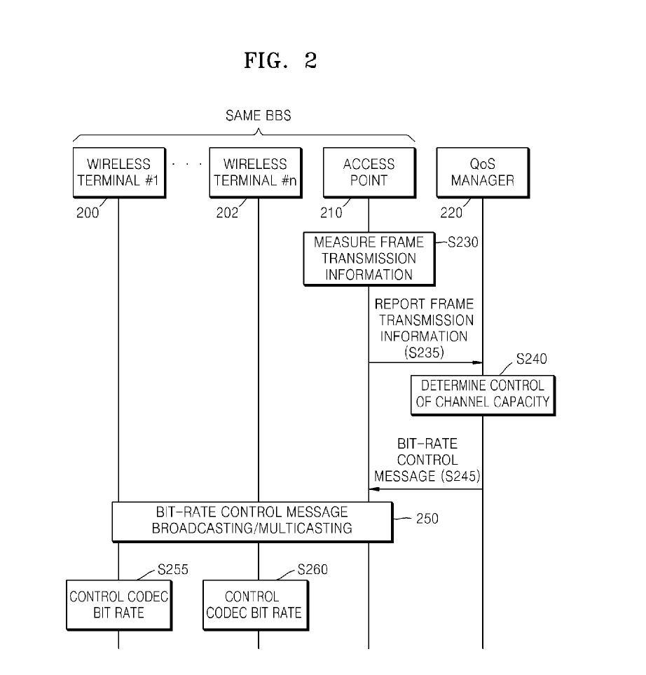

FIG. 2 is a flowchart illustrating a method for controlling voice quality according to an embodiment of the present invention.

Referring to FIG. 2, an AP 210 measures frame transmission information of wireless terminals 200 and 202 belonging to a BSS managed by the AP 210 (S230). Here, the frame transmission information is information for calculating the channel occupation time of each of the wireless terminals 200 and 202, and includes the number of frames and bytes received and transmitted between each of the wireless terminals 200 and 202 and the AP 210, a transmission speed, and the like. The frame transmission information also includes the MAC address and IP address for identifying the wireless terminals. The AP 210 transmits the measured frame transmission information to a QoS manager 220 to calculate channel capacity (S235). The transmission period of frame transmission information of the AP 210 may be set by the QoS manager 220. Preferably, the transmission period is determined such that the channel capacity can be precisely calculated.

The QoS manager 220 that has received the frame transmission information on each of the terminals from the AP sets the total capacity of wireless channels per time (e.g., 1 second) and then determines whether or not the channel capacity occupied by the terminals is controlled by calculating and comparing the occupancy of wireless channels occupied by the AP and the respective wireless terminals (S240). If it is not necessary to control the channel capacity, the QoS manager 220 maintains a current state. However, if it is necessary to control the channel capacity, the QoS manager 220 transmits the G.729.1 bit-rate control message of each of the wireless terminals 200 and 202 to the AP 210 (S245).

The bit-rate control message transmitted to the AP 210 by the QoS manager 220 is an Ethernet frame that has a destination to the AP 210, but objects receiving the bit-rate control message are practically the wireless terminals 200 and 202 included in the BSS of the AP 210. Therefore, the AP 210 broadcasts the G.729.1 bit-rate control message to be received by all the wireless terminals within the BSS (S250). If the bit-rate control message is transmitted only to a specific terminal of the BBS, the QoS manager 220 transmits a bit-rate control message containing a multicast address for specifying a specific receiving terminal to the AP 210, and the AP 210 multicasts the bit-rate control message in the BSS using a corresponding group address (S250). At this time, the broadcasting/multicasting is performed in the type of data frames. Preferably, frames are transmitted to an MAC upper layer of the receiving terminal.

Each of the wireless terminals 200 and 202 that has received the G.729.1 bit-rate control message from the AP 210 controls a G.729.1 bit rate under a command of the QoS manager 220 included in the received message (S255 and S260). At this time, voice data controlled by the bit-rate control are bi-directional data, i.e., transmitting and receiving voice data of a wireless terminal. The voice data may be controlled using maximum bit-rate supported (MBS) and frame type (FT) fields. That is, the QoS manager 220 newly sets values of the MBS and FT fields, thereby controlling the channel occupancy of each terminal.

Accordingly, the QoS manager 220 appropriately adjusts the bit rate of a wireless terminal with the embedded G.729.1 codec depending on the channel state in WLAN, thereby assuring the real-time QoS of voice.

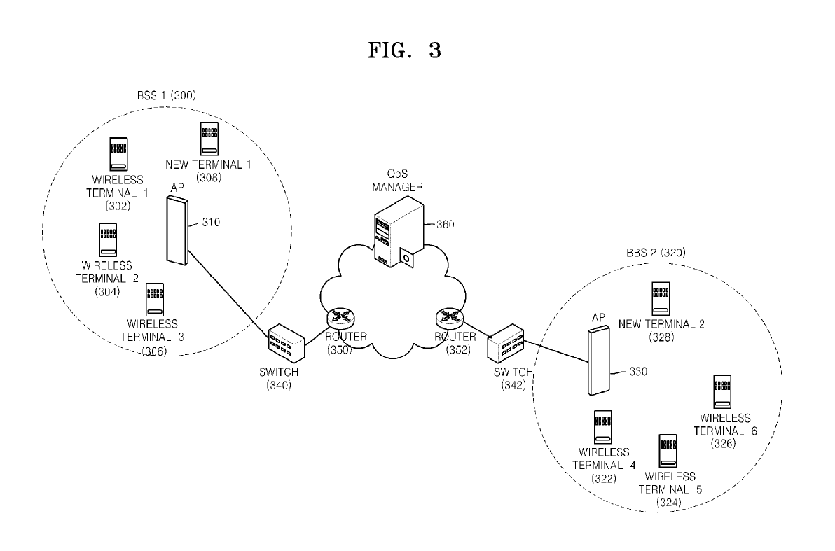

FIG. 3 is a view illustrating an example of the VoIP system to which a voice quality control is applied according to the present invention.

Referring to FIG. 3, the VoIP system includes a BSS1 300 and a BSS2 320, and each of the BBSs has APs 310 and 330 and wireless terminals 302 through 306 and 322 through 328. The APs 310 and 330 that exist in each of the BSSs are connected to the Internet through switches 340 and 342 and routers 350 and 352. A QoS manager 360 for controlling APs and each wireless terminal is positioned on the Internet.

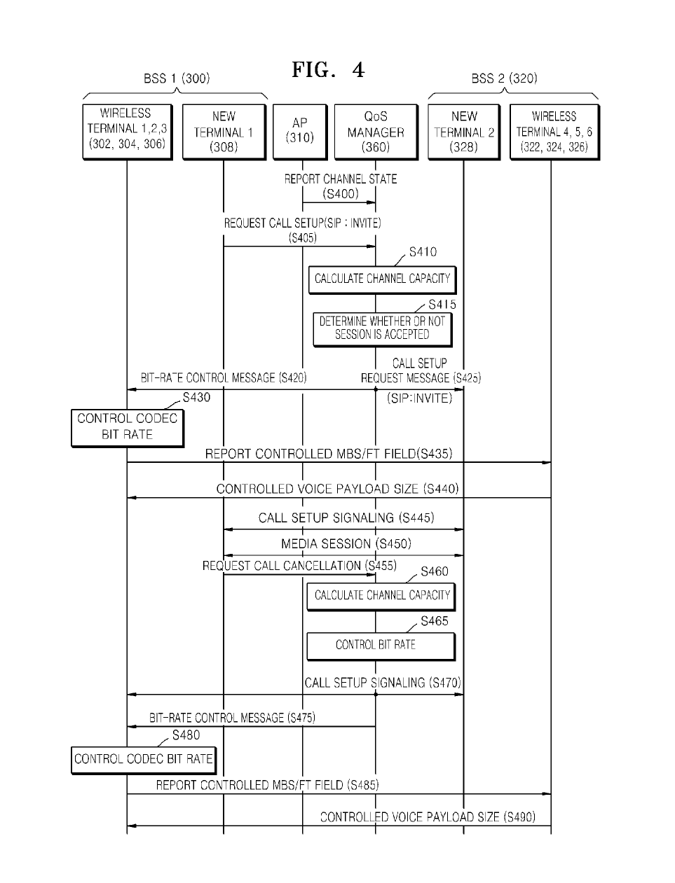

FIG. 4 is a flowchart illustrating a method for controlling voice quality in the VoIP system illustrated in FIG. 3 according to an embodiment of the present invention.

Referring to FIG. 4, it is assumed that most of the wireless terminals 302, 304 and 306 of the first BBS 300 communicate with the wireless terminals 322, 324 and 326 of the second BSS 320, and the wireless terminals 308 and 328 that do not perform voice communication exist in the first BSS 300 and the second BSS 320, respectively. In addition, it is assumed that all the wireless terminals have the G.729.1 broadband audio codec embedded therein.

First, the AP 310 of the first BSS 300 periodically reports information on a channel state in WLAN to the QoS manager 360 (S400). The reported period may be set by the QoS manager 360. The information on the channel state in WLAN includes parameters such as the number of frames and bytes received and transmitted between each of the wireless terminals 302, 304 and 306 and the AP 310, a transmission speed, and the like. The information also includes the MAC address and IP address of each for identifying the wireless terminals.

The new terminal 308 that does not perform voice communication transmits a voice communication session request message to the QoS manager 360 (S405). An INVITE message of session initiation protocol (SIP) may be used as the session request message. The session request message includes transmission information for media typeregestering of the G.729.1 codec embedded in the first new terminal 308. For example, the session request message may include information such as a maximum transmission speed (maxbitrate) at which a codec is supported in a corresponding session, a maximum transmission speed (mbs) of an encoder of a correspondent terminal in the session and a time length (ptime) expressed by media that exists in one packet.

When a session request is generated by the first new terminal 308, the QoS manager 360 calculates channel capacity (S410). The QoS manager 360 periodically updates the channel capacity occupied by the wireless terminals 302, 304 and 306, which have performed voice communication, from the channel state information reported by the AP 310. The channel capacity occupied by the first new terminal 308 relies on G.729.1 media information of the session request message provided to register a media type in a session request and WLAN transmission speed information of a terminal for data frame transmission.

The QoS manager 360 determines whether or not the session request of the first new terminal is accepted based on the calculated channel capacity (S415). Specifically, the QoS manager 360 sets threshold channel capacity considering spare channels for an abrupt change in channel quality in the total channel capacity assigned to the first BSS 300. For example, assuming that the total channel capacity is 1 second, the threshold channel capacity is set to be 0.9 second, considering a channel margin of 10%. The threshold channel capacity set as described above is compared with the previously calculated channel capacity. If the channel occupancy considering the first new terminal 308 requesting a session is below the threshold channel capacity, the QoS manager 360 accepts the session request. If the channel occupancy is the threshold channel capacity or more, the QoS manager 360 determines whether or not the G.729.1 bit rate is controlled. The G.729.1 bit-rate control is performed until the total channel occupancy occupied by the wireless terminals 302, 304 and 306 in the first BSS 300 and the AP 310 is smaller than the threshold channel capacity. If the total channel occupancy is greater than the threshold channel capacity although even the minimum bit rate of the G.729.1 codec is controlled, the session request is rejected.

When the session request is accepted, the QoS manager 360 transmits a call setup request message to a correspondent terminal of the first new terminal 308 requesting the session acceptance, i.e., the second new terminal 328 of the second BSS 320 (S425), and simultaneously transmits a G.729.1 bit-rate control message to the wireless terminals 302, 304 and 306 of the first BSS 300 (S420).

The wireless terminals 302, 304 and 306 that have received the bit-rate control message controls the bit rate of their own codec (G.729.1) (S430). That is, each of the wireless terminals 302, 304 and 306 adjusts the MBS or FT field of the codec in accordance with the bit-rate control message. When the MBS field is adjusted, the voice payload size received from the correspondent wireless terminals 322, 324 and 326 of the second BSS 320 is adjusted. When the FT field is adjusted, the voice payload size transmitted to the correspondent wireless terminals 322, 324 and 326 of the second BSS 320 is adjusted. Thus, the size of bi-directional voice data can be controlled using the MSB and FT fields.

The wireless terminals 322, 324 and 326 of the second BSS 320 receiving the MBS controlled from the wireless terminals 302, 304 and 306 of the first BSS 300 correct the encoder setting of the codec depending on the received MBS value and control the voice payload size transmitted to the wireless terminals 302, 304 and 306 of the first BSS 300 (S435 and S440).

Next, signaling for call setup between each of the new terminals 308 and 328 and the QoS manager 360 is performed (S445). An example of the process of setting up a call through SIP is as followed. Messages SIP:100 trying, SIP:180 ringing, SIP:200 OK and SIP:ACK are exchanged between the new terminals and the QoS manager.

If a call is accepted through the call setup signaling, a media session is opened

(S450), the voice data exchange between the new terminals is performed using real time protocol (RTP) packets.

When a call between the new terminals 308 and 328 is ended, the first new terminal 308 of the first BSS 300 request a call end to the QoS manager 360 (S455). Message SIP:BYE is used as one example of the call end request message.

The QoS manager 360 calculates a change in channel capacity due to the call end of the new terminal (S460). The QoS manager 360 maximizes the MBS/FT field values of the wireless terminals 302, 304 and 306 that perform voice communication within a range in which the channel capacity occupied by the wireless terminals 302, 304 and 306 of the first BSS 300 and the AP 310 is smaller than the threshold channel capacity (S465).

The new terminals 308 and 328 perform signaling for the call end with the QoS manager 360 (S470). For example, messages SIP:BYE and SIP:200 OK are exchanged between the new terminals and the QoS manager in SIP call end signaling. There is no more voice data exchange between the new terminals 308 and 328.

The QoS manager 360 transmits a bit-rate control message for controlling the bit rate of each of the wireless terminals to each of the terminals (S475). The wireless terminals 302, 304 and 306 that have received the bit-rate control message control their own codec bit rates (S480). That is, each of the wireless terminals 302, 304 and 306 newly sets the FT field for controlling the voice payload size transmitted from itself or the MBS field for controlling the voice payload size transmitted by each of the correspondent terminals 322, 324 and 326 in accordance with the bit-rate control message, and informs the correspondent terminals 322, 324 and 326 of the set value (S485).

The wireless terminals 322, 324 and 326 of the second BSS 320 receive the MBS value controlled from the wireless terminals 302, 304 and 306 of the first BSS 300 (S485). The wireless terminals 322, 324 and 326 correct the encoder setting of the codec depending on the received MBS value and then control the voice payload size transmitted to the terminals of the first BSS 300 depending on the corrected MBS field value (S490).

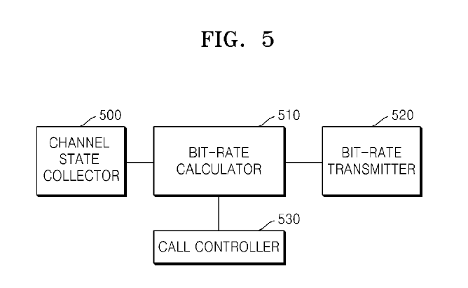

FIG. 5 is a block diagram illustrating an apparatus for controlling voice quality in WLAN according to an embodiment of the present invention.

Referring to FIG. 5, the apparatus for controlling voice quality includes a channel state collector 500, a bit-rate calculator 510, a bit-rate transmitter 520 and a call controller 530.

The cannel state collector 500 collects channel state information for determining a channel occupation time of wireless terminals connected to each AP. The channel state information for determining the channel occupation time includes the number of frames and bytes received and transmitted between the AP and wireless terminals in a BSS to which the AP belongs, a transmission speed, and the like. The frame transmission information also includes the MAC address and IP address of for identifying the wireless terminals. The channel state collector 500 may receive channel state information from the AP for each predetermined period.

The bit-rate calculator 510 calculates channel capacity occupied by the wireless terminals and the AP based on the collected channel state information, and calculates the channel occupancy rate of the wireless terminals and the AP with respect to the total channel capacity assigned to the BSS to which the AP belongs. The bit-rate calculator 510 controls the codec bit rate of each of the wireless terminals based on the channel occupancy rate. Specifically, the bit-rate calculator 510 sets threshold channel capacity considering spare channels in the total channel capacity. If the channel occupancy of the wireless terminals exceeds the threshold channel capacity, the bit-rate calculator 51 controls the codec bit rate of each of the wireless terminals.

The call controller 530 takes charge of call setting and call cancellation of a wireless terminal. Since a channel should be newly assigned or cancelled in the call setting or call cancellation, the total occupancy in a BSS is changed. Thus, the bit-rate calculator 510 re-controls the codec bit rate of the entire terminals based on the channel state information collected through the AP and the channel occupancy generated in the call setting and call cancellation.

The bit-rate transmitter 520 transmits the controlled codec bit rate to each of the wireless terminals. Specifically, the bit-rate transmitter 520 broadcasts or multicasts a bit-rate control message, in which an MBS field and/or an FT field are newly set, to each of the wireless terminals. The wireless terminals control their own bit rates of the G.729.1 codec depending on the MBS field and/or the FT field contained in the bit-rate control message.

In the present invention, recording media readable by a computer may be implemented with codes readable by the computer. The recording media readable by a computer includes all types of recording devices in which data readable by a computer system are stored. For example, the recording media readable by a computer are ROMs, RAMs, CD-ROMs, magnetic tapes, floppy disks, optical data storage devices and the like. In addition, the recording media readable by a computer may be implemented in the form of display by carrier waves (e.g., transmission on the Internet). The recording media readable by a computer are distributed in a computer system connected through networks such that codes readable by a computer through the distribution scheme can be stored and implemented.

While the present invention has been particularly shown and described with reference to exemplary embodiments thereof, it will be understood by those of ordinary skill in the art that various changes in form and details may be made therein without departing from the spirit and scope of the present invention as defined by the following claims.

Most VoIP systems support the G.711 or G.729 codec, considering characteristics of the G.729.1 and channel in WLAN. In the situation, if the G.729.1 is applied to the VoIP systems, the G.729.1 is compatible for the G.729 codec, and the quantity of voice data is controlled using variable bit-rate characteristics of the G.729.1. Accordingly, the QoS of voice can be assured.

1. A method for controlling voice quality in a VoIP system, the method comprising:
collecting channel state information for determining a channel occupation time of wireless terminals connected to an access point (AP);
adjusting the codec bit rate of the wireless terminals based on channel occupancy of the wireless terminals with respect to total channel capacity, which is determined using the channel state information; and
transmitting the adjusted codec bit rate.

2. The method of claim 1, wherein the channel state information includes the number of frames and bytes received and transmitted between the AP and the respective wireless terminals, and a transmission speed.

3. The method of claim 1, wherein the receiving of the channel state information comprises receiving the channel state information from the AP for each predetermined period.

4. The method of claim 1, wherein the adjusting of the codec bit rate comprises setting the total channel capacity per time.

5. The method of claim 1, wherein the adjusting of the codec bit rate comprises:
setting threshold channel capacity considering spare channels in the total channel capacity; and
adjusting the codec bit rate of the wireless terminals when the channel occupancy exceeds the threshold channel capacity.

6. The method of claim 1, wherein the adjusting of the codec bit rate comprises:
determining channel capacity changed depending on a call setup request or a call setup cancellation of the wireless terminal; and
adjusting the codec bit rate of the wireless terminals based on the channel occupancy of the wireless terminals with respect to the total channel capacity, which is determined considering the changed channel capacity.

7. The method of claim 1, wherein the adjusting of the codec bit rate comprises adjusting a bit rate for determining a voice payload size transmitted by the wireless terminals or a voice payload size received from correspondent terminals that perform voice communication with the wireless terminals.

8. The method of claim 1, wherein the adjusting of the codec bit rate comprises adjusting the bit rate of the G.729.1 codec.

9. The method of claim 1, wherein the transmitting of the controlled codec bit rate comprises transmitting a bit-rate control message containing a multicast address for specifying only wireless terminals, of which codec bit rate is adjusted.

10. The method of claim 1, wherein the transmitting of the adjusted codec bit rate comprises broadcasting information on the adjusted codec bit rate to all the wireless terminals connected to the AP.

11. An apparatus for controlling voice quality in VoIP, comprising:
a channel state collector for collecting channel state information for determining a channel occupation time of wireless terminals connected to an AP;
a bit-rate calculator for adjusting the codec bit rate of the wireless terminals based on channel occupancy of the wireless terminals with respect to total channel capacity, which is determined using the channel state information; and
a bit-rate transmitter for transmitting the adjusted codec bit rate.

12. The apparatus of claim 11, wherein the channel state collector collects the channel state information including the number of frames and bytes received and transmitted between the AP and the respective wireless terminals, and a transmission speed.

13. The apparatus of claim 11, wherein the channel state collector receives the channel state information from the AP for each predetermined period.

14. The apparatus of claim 11, wherein the bit-rate calculator sets the total channel capacity per time.

15. The apparatus of claim 11, wherein the bit-rate calculator sets threshold channel capacity considering spare channels in the total channel capacity and adjusts the codec bit rate of the wireless terminals when the channel occupancy exceeds the threshold channel capacity.

16. The apparatus of claim 11, further comprising a call controller for setting or canceling a call of a wireless terminal depending on a call setup request or a call setup cancellation of the wireless terminal,
wherein the bit-rate calculator determines channel capacity changed depending on the call setup request or a call setup cancellation of the wireless terminal and adjusts the codec bit rate of the wireless terminals based on the channel occupancy of the wireless terminals with respect to the total channel capacity, which is determined considering the changed channel capacity.

17. The apparatus of claim 11, wherein the bit-rate calculator adjusts a bit rate for determining a voice payload size transmitted by the wireless terminals or a voice payload size received from correspondent terminals that perform voice communication with the wireless terminals.

18. The apparatus of claim 11, wherein the bit-rate calculator adjusts the bit rate of the G.729.1 codec.

19. The apparatus of claim 11, wherein the bit-rate transmitter transmits a bit-rate control message containing a multicast address for specifying only wireless terminals, of which codec bit rate is adjusted.

20. The apparatus of claim 11, wherein the bit-rate transmitter broadcasts information on the adjusted codec bit rate to all the wireless terminals connected to the AP.

21. A method for controlling voice quality in a VoIP system, the method comprising:
receiving a call setup request from a new terminal;
determining channel occupancy with respect to a total channel capacity of existing terminals connected to the same AP as the new terminal;
adjusting the codec bit rate of the existing terminals based on the total channel occupancy of the new terminal and the existing terminals with respect to the total channel capacity, which is determined considering channel capacity to be occupied by the new terminal; and
transmitting the adjusted codec bit rate.

22. The method of claim 21, wherein the channel capacity to be occupied by the new terminal is determined from media information of the codec used by the new terminal.

23. The apparatus of claim 11, further comprising canceling the call setup request when the total channel occupancy at which the codec bit rate of the existing terminals is minimized is greater than a previously set threshold value.
